(19) United States
(12) Patent Application Publication
(10) Pub. No.: US 2023/0350078 A1
(43) Pub. Date: Nov. 2, 2023

(54) METHOD AND APPARATUS FOR GNSS OPERATION IN NON-TERRESTRIAL NETWORKS

(71) Applicant: Samsung Electronics Co., Ltd., Suwon-si (KR)

(72) Inventor: Carmela Cozzo, San Diego, CA (US)

(21) Appl. No.: 18/301,813

(22) Filed: Apr. 17, 2023

Related U.S. Application Data
(60) Provisional application No. 63/335,663, filed on Apr. 27, 2022.
(60) Provisional application No. 63/442,656, filed on Feb. 1, 2023.

(51) Int. Cl. G01S 19/31; H04W 24/10

(52) U.S. Cl. CPC G01S 19/31; H04W 24/10; H04W 84/06

(57) ABSTRACT

Methods and apparatuses for global navigation satellite system (GNSS) operation in a non-terrestrial network (NTN). A method includes receiving information relating to a measurement gap for GNSS measurements and a first time interval for transmission of feedback information associated with the GNSS measurements. The method further includes determining, based on the information relating to the measurement gap, a start of the measurement gap; the feedback information associated with the GNSS measurements during the measurement gap; and, based on the information relating to the first time interval, a transmission time for the feedback information. The method further includes transmitting the feedback information at the transmission time.

### CROSS-REFERENCE TO RELATED APPLICATIONS AND CLAIM OF PRIORITY

The present application claims priority to U.S. Provisional Patent Application No. 63/335,663, filed on Apr. 27, 2022, and U.S. Provisional Patent Application No. 63/442,656, filed on Feb. 1, 2023. The contents of the above-identified patent documents are incorporated herein by reference.

### TECHNICAL FIELD

The present disclosure relates generally to wireless communication systems and, more specifically, the present disclosure relates to a global navigation satellite system (GNSS) operation in a non-terrestrial network (NTN) in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to a GNSS operation in an NTN in a wireless communication system.

In one embodiment, a user equipment (UE) is provided. The UE includes a transceiver configured to receive information relating to a measurement gap for Global Navigation Satellite System (GNSS) measurements and a first time interval for transmission of feedback information associated with the GNSS measurements. The UE further includes a processor operably coupled to the transceiver, the processor configured to determine, based on the information relating to the measurement gap, a start of the measurement gap; the feedback information associated with the GNSS measurements during the measurement gap; and, based on the information relating to the first time interval, a transmission time for the feedback information. The transceiver is further configured to transmit the feedback information at the transmission time.

In another embodiment, a base station (BS) is provided. The BS includes a transceiver configured to transmit information relating to a measurement gap for GNSS measurements and a first time interval for reception of feedback information associated with the GNSS measurements. The BS further includes a processor operably coupled to the transceiver, the processor configured to determine, based on the information relating to the measurement gap, a start of the measurement gap; the feedback information associated with the GNSS measurements during the measurement gap; and, based on the information relating to the first time interval, a reception time for the feedback information. The transceiver is further configured to receive the feedback information at the reception time.

In yet another embodiment, a method is provided. The method includes receiving information relating to a measurement gap for GNSS measurements and a first time interval for transmission of feedback information associated with the GNSS measurements. The method further includes determining, based on the information relating to the measurement gap, a start of the measurement gap; the feedback information associated with the GNSS measurements during the measurement gap; and, based on the information relating to the first time interval, a transmission time for the feedback information. The method further includes transmitting the feedback information at the transmission time.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6 illustrates a flowchart of a UE method for determining a TA for a transmission of a PUSCH with repetitions when a GNSS position becomes outdated according to embodiments of the present disclosure;

FIG. 7 illustrates a flowchart of a UE method for requesting satellite ephemeris and/or common TA according to embodiments of the present disclosure;

FIG. 8 illustrates a flowchart of a UE method for determining a new GNSS position according to embodiments of the present disclosure;

FIG. 9 illustrates an example of timing relationship of measurement gaps and transmission of GNSS reports according to embodiments of the present disclosure;

FIG. 10 illustrates a flowchart of a UE method for configuring gaps for GNSS measurements and enabling to perform GNSS measurements and reports according to embodiments of the present disclosure; and

FIG. 11 illustrates a flowchart of UE method for reporting a GNSS position according to embodiments of the present disclosure.

### DETAILED DESCRIPTION

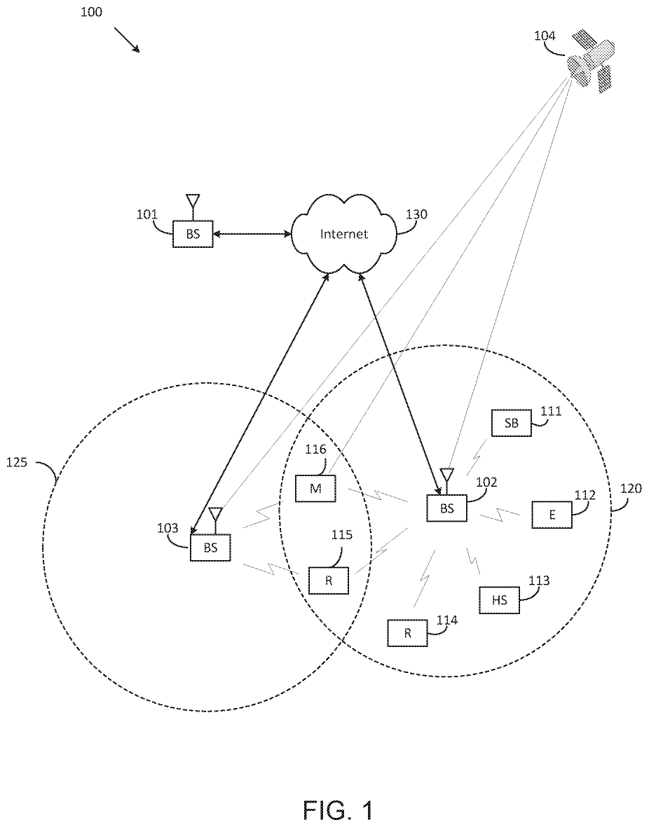

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents are hereby incorporated by reference into the present disclosure as if fully set forth herein: 3GPP, TR 38.811 v15.2.0, “Study on NR to support non-terrestrial networks”; 3GPP, TR 38.821 v16.0.0, “Solutions for NR to support non-terrestrial networks (NTN)”; 3GPP, TS 38.331 v17.0.0, “5G; NR; Radio Resource Control (RRC); Protocol specification”; 3GPP, TS 38.304 v17.0.0, 5G; “NR; User Equipment (UE) procedures in idle mode and in RRC Inactive state”; 3GPP, TS 37.355 v17.0.0, “Technical Specification Group Radio Access Network; LTE Positioning Protocol (LPP)”; 3GPP, TS 38.300 v17.0.0, “5G; NR; NR and NG-RAN Overall description; Stage-2”; and 3GPP, TS 38.133 v17.0.0, “5G; NR; Requirements for support of radio resource management.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably-arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

As described in more detail below, one or more of the UEs 111-116 include circuitry, programing, or a combination thereof for supporting a global navigation satellite system (GNSS) operation in non-terrestrial networks (NTN) in a wireless communication system. One or more of the gNBs 101-103 includes circuitry, programing, or a combination thereof, for supporting a global navigation satellite system (GNSS) operation in non-terrestrial networks (NTN) in a wireless communication system.

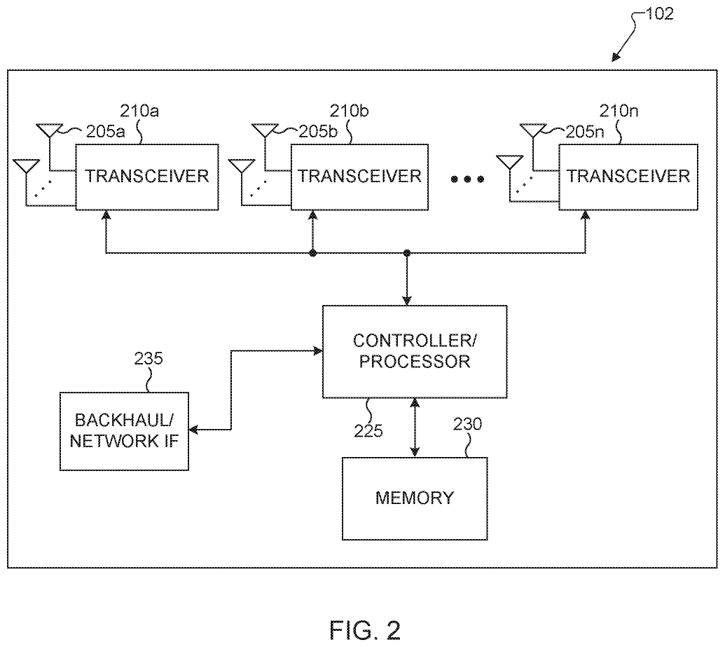

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for supporting GNSS operation in NTN. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

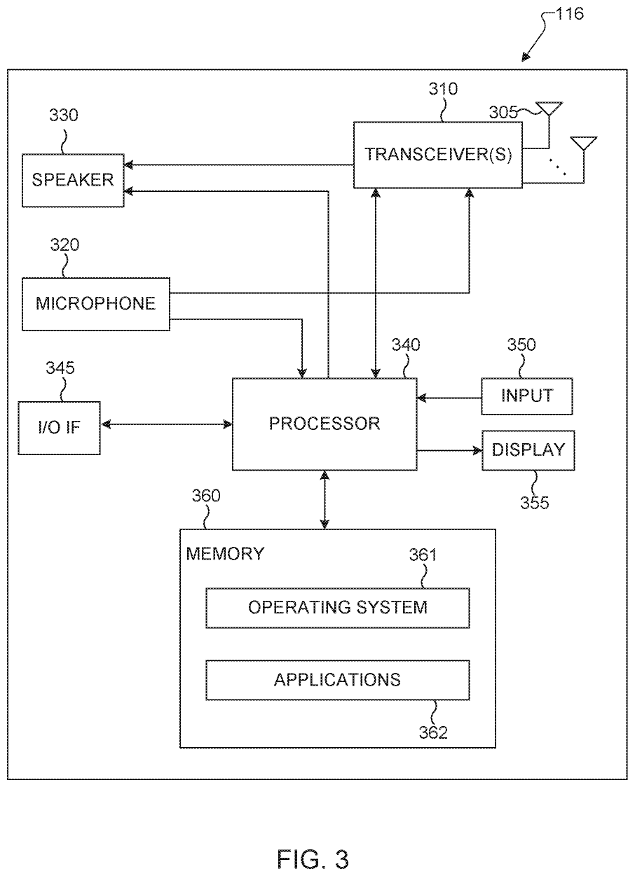

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, 415 from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for supporting GNSS operations in NTN. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

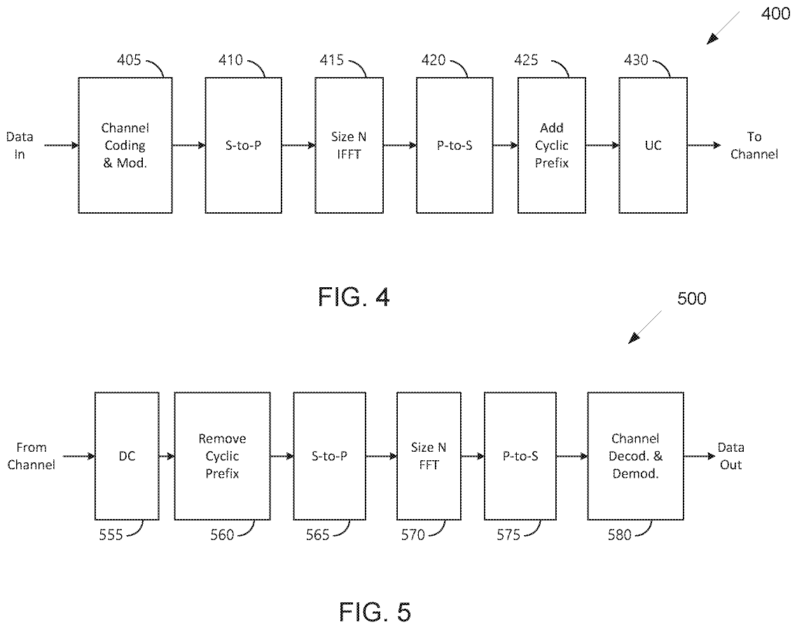

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support GNSS operation in NTN as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNB s 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNB s 101-103.

Each of the components in FIG. 4 and FIG. 5 can be implemented using only hardware or using a combination of hardware and software/firmware. As a particular example, at least some of the components in FIGS. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A UE with GNSS capability can acquire its GNSS position and autonomously pre-compensate the TA for the long propagation delay and the frequency Doppler shift experienced on the service link considering also the common timing advance and the satellite position through the satellite ephemeris, if configured. In a connected mode, the UE continuously updates the TA and frequency pre-compensation, but the UE is not expected to perform GNSS acquisition. Timers associated with satellite ephemeris, common timing advance or a GNSS position ensure that the UE does not perform any transmissions while satellite ephemeris, common timing advance or a GNSS position are outdated. In that case the UE assumes that the UE has lost uplink synchronization.

In a connected mode, when satellite ephemeris and common timing advance become outdated, the UE re-acquires new broadcasted parameters, and when a GNSS position becomes outdated the UE moves to an idle mode. Alternatively, to the UE moving to an idle mode when the GNSS position becomes outdated, the UE can continue to use satellite ephemeris and common timing advance to estimate the TA and can feedback to the network that an update position from its GNSS is not available. In response the network can broadcast satellite ephemeris and common timing advance and the UE estimates the TA with the received new information.

The network can also use the information that the UE is not able to estimate its GNSS position and adjust the scheduling. When the UE is able to reacquire its GNSS position, the UE can signal to the network that its GNSS operation is available. Thus, there is a need to establish a common understanding between the UE and the network about the UE being able to estimate its GNSS position. There is another need for the UE to feedback to the network when the GNSS position cannot be acquired or when the GNSS position can be reacquired. There is yet another need for the network to respond to the feedback provided by the UE by broadcasting updated satellite ephemeris and/or common timing advance, and/or by updating timer durations, and/or by adjusting the scheduling.

In the present disclosure, embodiments described for NR or for NB-IoT or for LTE-MTC operating in an NTN equally apply to NR, NB-IoT and LTE-MTC. The terms “gNB” and “eNB” indicate a base station which can be part of a NR-based or LTE-based network, and are interchangeably used.

In the present disclosure, embodiments described for a PUSCH transmission are equally applicable to a PUCCH, a PRACH, or an SRS transmission, and embodiments described for a transmission of a repetition of an uplink channel are equally applicable to a transmission of an uplink channel or signal without repetitions. Additionally, the terms “time window,” “GNSS measurement gap” and “GNSS gap” indicate a time interval over which the UE can perform GNSS measurements to determine its GNSS position, and are interchangeably used.

An NTN is a network using RF resources on board a satellite or an unmanned aerial service (UAS) platform, and includes satellite which can be a geostationary earth orbiting (GEO) satellite served by one or several sat-gateways which are deployed across the satellite targeted coverage or a non-GEO satellite served successively by one or several satellite-gateways at a time, a radio link between a sat-gateway and the satellite or UAS platform, a radio link between the UE and the satellite or UAS platform. A satellite or UAS platform may implement either a transparent or a regenerative (with on board processing) payload. The satellite or UAS platform typically generates several beams over a given service area bounded by a field of view which depends on the on board antenna diagram and elevation angle. The footprint of a beam has an elliptic shape and is considered as a cell in terrestrial networks.

Propagation delays in an NTN are much larger than propagation delays in terrestrial mobile systems which are usually less than 1 ms, ranging from several milliseconds to hundreds of milliseconds depending on the altitudes of the spaceborne or airborne platforms and payload type in an NTN. The cell size in an NTN is much larger and UE in different parts of the cell experience different delays. Thus, the long propagation delays and large cell size require modifications of the timing aspects defined in terrestrial networks both at the physical layer and higher layers, including the timing advance (TA) mechanism.

For an NTN, timing relationships involving DL-UL timing interaction need to be enhanced by adding a scheduling offset. One scheduling offset is K_{offset} which is the round trip time (RTT) between the UE and the uplink time synchronization reference point (RP) and corresponds to the sum of the service link RTT and the common TA, if indicated. For initial access, the information of K_{offset} is carried in system information. An update of K_{offset} after initial access can be done. The UE-specific K_{offset} can be provided and updated by the network with MAC CE. Another scheduling offset is K_{mac} which is the RTT between the RP and the gNB and is a scheduling offset supported in NTN for MAC CE timing relationships enhancement. It is provided by the network if downlink and uplink frame timing are not aligned at the gNB, and is needed for UE transmission and reception based on a downlink configuration indicated by a MAC CE command in PDSCH.

A TA is an offset applied by a UE to an uplink transmission to ensure that downlink and uplink frames are synchronized at a gNB. The gNB can measure the timing of the uplink signal from each UE and adjust the uplink transmission timing by sending a TA to the respective UE. When the UE transmits, e.g., PRACH, PUSCH, PUCCH, SRS, etc., the gNB can estimate an uplink signal arrival time which can then be used to calculate the required TA. The gNB can estimate an initial TA from PRACH and send a TA signaling in a random access response (RAR). Once the UE is in a connected mode, the gNB can estimates the TA value and, if a correction is needed, send the TA value to the UE by MAC CE. The gNB can also send a same TA value to all UEs in a cell. The UE can estimate the TA and, if configured, report the TA to a gNB during initial access or in a connected mode. It is also possible that in a connected mode reporting of the TA is triggered by the gNB.

For the calculation of the TA the UE is assisted by its GNSS and by the network which periodically broadcasts assistance information including serving satellite ephemeris and higher layer common-TA-related parameters. For the TA calculation the UE uses its GNSS acquired position together with the serving satellite ephemeris indicated by the network and/or uses a GNSS acquired reference time at the UE together with the reference time indicated by the network. The TA calculation includes various factors: T_{TA}=(N_{TA}+N_{TA,offset}+N_{TA,adj}^{common}+N_{TA,adj}^{UE})T_{c}. N_{TA} is a timing advance value relative to the SCS of the first uplink transmission from the UE after the reception of the random access response or absolute timing advance command MAC CE.

A UE can be provided a value N_{TA,offset} of a timing advance offset for a serving cell by higher-layer parameter n-TimingAdvanceOffset for the serving cell. If the UE is not provided n-TimingAdvanceOffset for a serving cell, the UE determines a default value N_{TA,offset} of the timing advance offset for the serving cell. N_{TA,adj}^{common} is a network-controlled common TA that may include any timing offset considered necessary by the network (e.g., feeder link delay). It is derived from the higher-layer parameters TACommon, TACommonDrift, and TACommonDriftVariation if configured, otherwise N_{TA,adj}^{common}=0. N_{TA,adj}^{UE} is estimated by the UE to pre-compensate for the service link delay. It is computed by the UE based on a UE position and serving satellite-ephemeris-related higher-layers parameters if configured, otherwise N_{TA,adj}^{UE}=0.

A UE with GNSS capability can acquire its GNSS position and autonomously pre-compensate the TA for the long propagation delay and the frequency Doppler shift experienced on the service link considering also the common TA and the satellite position through the satellite ephemeris, if configured. In a connected mode, the UE continuously updates the TA and frequency pre-compensation, but the UE is not expected to perform GNSS acquisition. Timers associated with satellite ephemeris, common TA or a GNSS position ensure that the UE does not perform any transmissions while satellite ephemeris, common TA or a GNSS position are outdated. In that case the UE assumes that the UE has lost uplink synchronization.

In a connected mode, when satellite ephemeris and common TA become outdated, the UE re-acquires new broadcasted parameters, and when a GNSS position becomes outdated the UE moves to an idle mode. Alternatively, to the UE moving to an idle mode when the GNSS position becomes outdated, the UE can continue to use satellite ephemeris and common TA to estimate the TA and can feedback to the network that an update position from its GNSS is not available. In response the network can broadcast satellite ephemeris and common TA and the UE estimates the TA with the received new information. The network can also use the information that the UE is not able to estimate its GNSS position and adjust the scheduling.

When the UE is able to reacquire its GNSS position, the UE can signal to the network that its GNSS operation is available. Thus, there is a need to establish a common understanding between the UE and the network about the UE being able to estimate its GNSS position. There is another need for the UE to feedback to the network when the GNSS position cannot be acquired or when the GNSS position can be reacquired. There is yet another need for the network to respond to the feedback provided by the UE by broadcasting updated satellite ephemeris and/or common timing advance, and/or by updating timer durations, and/or by adjusting the scheduling.

A UE in a connected mode updates the TA and frequency pre-compensation based on satellite ephemeris and common TA broadcasted by the network. A GNSS position is acquired during initial access and remains valid for a period of time depending on a validity timer. When the timer expires, the GNSS position becomes outdated. The UE can operate with the outdated GNSS position to complete an ongoing transmission and then transition to an idle mode and acquire a new GNSS position. It is also possible that the UE operates with the outdated GNSS position for a (pre-)configured or indicated time interval after expiration of the timer if there is an ongoing transmission, and after the (pre-)configured or indicated time interval the UE terminates the transmission.

For example, when the UE is scheduled to transmit a PUSCH with a number of Nᵣₑₚ repetitions over a number of consecutive or non-consecutive slots, and its GNSS position becomes outdated in slot m before completion of all repetitions the UE can complete the transmission of the PUSCH repetitions or interrupt the transmission after the slot where the GNSS position becomes outdated in slot m+1 or after a pre-configured number of slots after the slot where the GNSS position becomes outdated in slot m+n+1.

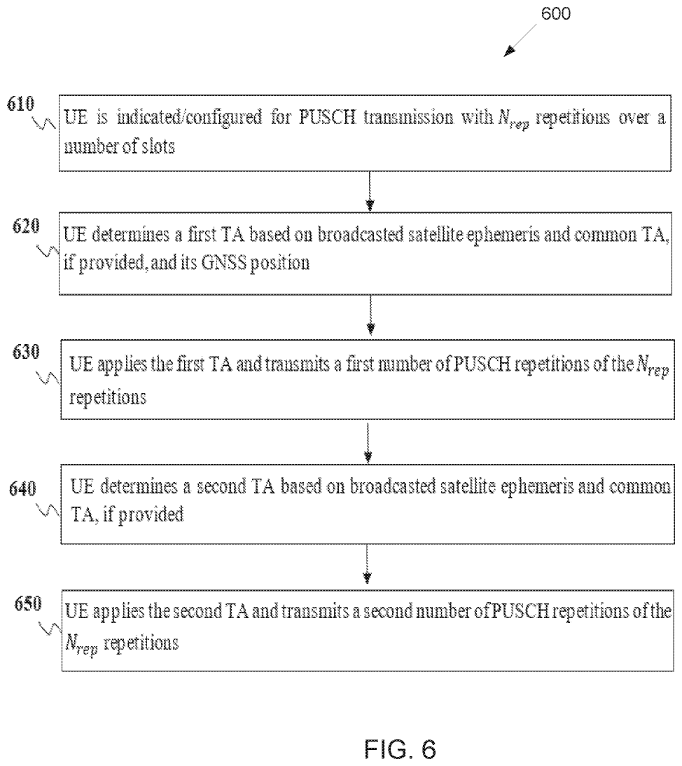

FIG. 6 illustrates a flowchart of a UE method 600 for determining a TA for a transmission of a PUSCH with repetitions when a GNSS position becomes outdated according to embodiments of the present disclosure. The method 600 as may be performed by a UE (e.g., 111-116 as illustrated in FIG. 1). An embodiment of the method 600 shown in FIG. 6 is for illustration only. One or more of the components illustrated in FIG. 6 can be implemented in specialized circuitry configured to perform the noted functions or one or more of the components can be implemented by one or more processors executing instructions to perform the noted functions.

A UE is indicated/configured for PUSCH transmission with Nᵣₑₚ repetitions over a number of slots (610). The UE determines a first TA based on broadcasted satellite ephemeris and common TA, if provided, and its GNSS position (620). The UE applies the first TA and transmits a first number of PUSCH repetitions of the Nᵣₑₚ repetitions (630). The UE determines a second TA based on broadcasted satellite ephemeris and common TA, if provided (640). The UE applies the second TA and transmits a second number of PUSCH repetitions of the Nᵣₑₚ repetitions (650).

Whether to complete an ongoing transmission or interrupt it after the GNSS position becomes outdated can be provided by a higher-layer parameter in a SIB or by a UE-specific configuration. It can depend on a priority associated to the transmission of a channel, wherein the channel can be a PUSCH transmission configured by ConfiguredGrantConfig, a PUSCH transmission scheduled by DCI format 0_1 or corresponding to a Type 2 configured grant activated by DCI format 0_1, a PUSCH transmission scheduled by DCI format 0_2 or corresponding to a Type 2 configured grant activated by DCI format 0_2, a PUSCH repetition Type A transmission, or a PUSCH repetition Type B transmission. The channel can also be a PUCCH transmission with HARQ-ACK information corresponding to a DCI format detected by the UE that schedules a SPS PDSCH reception, or schedules a SPS PDSCH release, or indicates SCell dormancy through a PDCCH reception, or requests Type-3 HARQ-ACK codebook report, a PUCCH transmission with SR, or a PUCCH transmission with CSI. A PUCCH transmission can be with repetitions, wherein the UE can be configured a number of slots, N_{PUCCH}^{repeat}, for repetitions of the PUCCH transmission, or can be configured a number of repetitions in a PUCCH Resource Indicator (PRI) field. It can also depend on whether the channel is transmitted by an NB-IoT or eMTC UE or by an NR device.

After a GNSS position becomes outdated and the TA is valid based on validity timers for satellite ephemeris and common TA, if provided, and this event happens during a transmission with repetitions, the UE can autonomously decide whether to transmit all or some of the remaining repetitions after the event. It is possible that the UE default behavior is to complete the transmission of the remaining repetitions unless the UE is configured not to transmit after the event. Alternatively, the UE default behavior can be not to transmit after the event unless the UE is configured to complete the transmission of the remaining repetitions. It is possible that the UE continues to transmit when the TA is valid independently of whether the GNSS position has become outdated or not. After the UE completes the transmission, the UE performs measurements during a measurement gap to update its GNSS position fix, wherein the GNSS measurement gap can be the next configured gap after the slot where the transmission is complete, or the measurement gap indicated by a MAC CE of by a DCI format which may be received by the UE after the UE sends a request to the gNB to schedule a measurement gap. The request from the UE to the gNB can be by MAC CE.

When a UE cannot reacquire a GNSS position the UE can request to the network to transmit satellite ephemeris and/or a common TA so that the UE can update the TA based on the new information. The UE can receive the new information in a physical DL channel or through MAC CE. For example, the UE receives a DCI format that schedules a PDSCH that includes the new information. The UE then updates TA and frequency pre-compensation, and restarts a validity timer starting from a slot n, wherein slot n is the slot where the time and frequency compensation is applied. The validity timer can be associated to the satellite ephemeris and can be same or different than the value provided for the satellite ephemeris that the network periodically broadcasts or can be associated to common TA or to both. For example, the UE chooses the smallest value between the two values of the validity timers or monitors two timers.

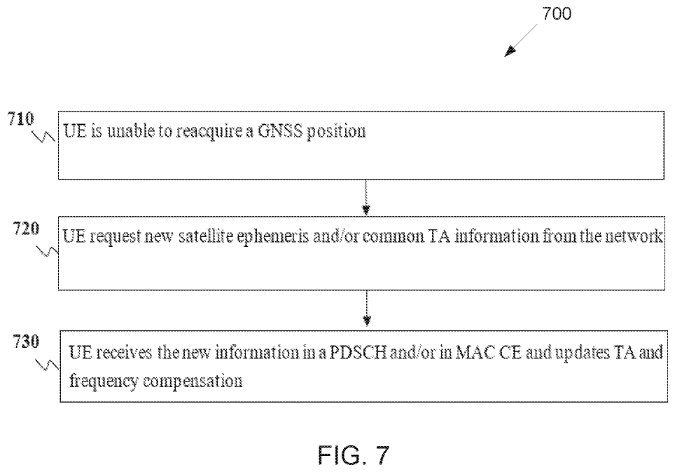

FIG. 7 illustrates a flowchart of a UE method 700 for requesting satellite ephemeris and/or common TA according to embodiments of the present disclosure. The method 700 as may be performed by a UE (e.g., 111-116 as illustrated in FIG. 1). An embodiment of the method 700 shown in FIG. 7 is for illustration only. One or more of the components illustrated in FIG. 7 can be implemented in specialized circuitry configured to perform the noted functions or one or more of the components can be implemented by one or more processors executing instructions to perform the noted functions.

A UE is unable to reacquire a GNSS position (710). The UE request new satellite ephemeris and/or common TA information from the network (720). The UE receives the new information in a PDSCH and/or in MAC CE, and updates TA and frequency compensation (730).

Additionally or alternatively to requesting satellite ephemeris and/or common TA information from the network when its GNSS position is outdated, a UE can indicate to the network that its GNSS position is outdated. In one example, the network can indicate to the UE to transition to idle or inactive mode to perform GNSS measurements to acquire a new GNSS position. When a new GNSS position is acquired, the UE indicates the new GNSS position to the network.

In another example, the network indicates to the UE in a DCI format or in MAC CE to perform GNSS measurements within a time window while in a connected mode, wherein the time window has a maximum length in number of symbols or slots provided by a higher layer parameter or by a pre-configured fixed value, and a starting slot which is the slot where the indication to perform GNSS measurements is received or a subsequent slot. Upon acquiring a new GNSS position, the UE indicates the GNSS position to the network and stops performing measurements. The new GNSS position can be used by the UE to update the TA and frequency pre-compensation, or the UE waits to perform the updates until reception of an indication and/or a new common TA by the network.

Whether the UE can be configured/indicated to perform GNSS measurements in idle, inactive or a connected mode can be subject to a UE capability. For example, a UE capable of performing GNSS measurements in a connected mode indicates such capability to the network, and when the UE indicates that the GNSS position is outdated or equivalently requests to perform GNSS measurements, the UE receives the indication to perform measurements. It is also possible that the UE sends the indication that the GNSS position is outdated to the network and starts performing GNSS measurements after a number of symbols or slots from the symbol used for the uplink indication, without waiting for an indication provided by the network. The UE can perform measurements within a time window and if within the time window the UE is not able to acquire a new GNSS position, the UE indicates that the attempt to acquire the new GNSS position was not successful to the network, or the UE transitions to idle mode. At any time during the time window, if the UE is able to acquire the new GNSS position, the UE sends the new GNSS position to the network.

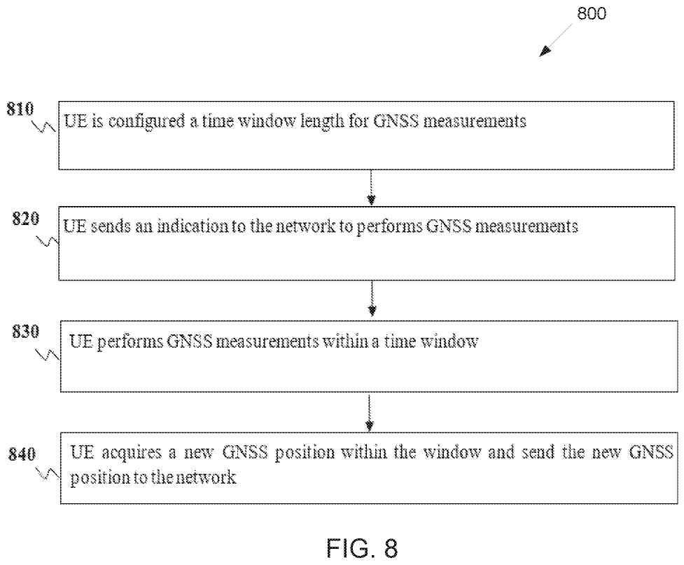

FIG. 8 illustrates a flowchart of a UE method 800 for determining a new GNSS position according to embodiments of the present disclosure. The method 800 as may be performed by a UE (e.g., 111-116 as illustrated in FIG. 1). An embodiment of the method 800 shown in FIG. 8 is for illustration only. One or more of the components illustrated in FIG. 8 can be implemented in specialized circuitry configured to perform the noted functions or one or more of the components can be implemented by one or more processors executing instructions to perform the noted functions.

A UE is configured a time window length for GNSS measurements (810). The UE sends an indication to the network to performs GNSS measurements (820). The UE performs GNSS measurements within a time window (830). The UE acquires a new GNSS position within the window and send the new GNSS position to the network (840).

A UE can receive a request to feedback its GNSS position to the network. The request can be to feedback the GNSS position that the UE has at the time of the request. It is also possible that the request is to perform new GNSS measurements within a time window and the feedback is the newly acquired GNSS position to the network.

When a UE performs GNSS measurements in a configured gap and acquires its GNSS position, the UE may determine a position based on signals received from GNSS without assistance from the network, or based on network-assisted GNSS methods that rely on signalling between a UE GNSS receiver and a continuously operating GNSS reference receiver network, which has clear sky visibility of the same GNSS constellation as the assisted UE. In a first network-assisted GNSS method, the UE may perform GNSS measurements (pseudo-ranges, pseudo Doppler, carrier phase ranges, etc.) and send these measurements to the LMF where the position calculation takes place, possibly using additional measurements from other (non GNSS) sources (UE-Assisted), or may perform GNSS measurements and calculate its own location, possibly using additional measurements from other (non GNSS) sources and assistance data from the LMF (UE-Based).

When a UE derives its position from GNSS measurements and determines a validity duration of the GNSS measurements, and hence of its GNSS position, the UE reports an information associated with the validity duration to the network via RRC signaling. Since the validity duration of the GNSS measurements may change from a first GNSS measurement to a second GNSS measurement, the UE reports the validity duration when the validity duration changes or report the validity duration associated with each measurement, and the report can be by RRC signaling or MAC CE or DCI format. The UE can report a new value of the validity duration, or report an indication for an adjustment of the validity duration of a predetermined value. The adjustment can be an increase or a decrease of the validity duration that is assumed by the network based on an earlier information provided by the UE, and the indication of the adjustment can be provided by RRC signaling, MAC CE or DCI format.

A network can configure gaps for GNSS measurements with a periodicity associated with the validity duration provided by the UE, and with a gap duration associated with a UE capability of performing GNSS measurements within a maximum time interval. If the network does not receive information of the maximum time interval needed by the UE to perform the GNSS measurements, a default value is assumed by the network and indicated to the UE by a SIB, a UE-specific RRC parameter, a MAC CE, or a DCI format. The UE can be indicated to perform GNSS measurements in the next configured gap by a DCI format or by a MAC CE. If the UE does not receive the indication, the UE may not perform GNSS measurements during the next configured gap, and resources during the next configured gaps can be used for reception or transmission depending on whether the UE operates in paired or unpaired spectrum, on whether the UE is a half-duplex UE that is not capable of simultaneous transmissions and receptions or is a full-duplex UE capable of simultaneous transmissions and receptions in paired spectrum or in sub-bands of a BWP, on a slot format configuration, on a configuration of frequency resources for UL or DL within an active BWP, or an a combination of the above.

When the UE receives a first indication to perform GNSS measurements in the configured gaps, the first indication may apply to the next configured gap, or to a number of subsequent configured gaps, or until a second indication to stop GNSS measurements in the configured gaps is received by the UE. Thus, the first indication can enable or activate GNSS measurements (and associated reports) in the next configured gap, in the number of subsequent configured gaps, or in the subsequent configured gaps. It is possible that the UE receives a second indication that disables or de-activates GNSS measurements (and associated reports) in the next configured gap, in the number of subsequent configured gaps, or in the subsequent configured gaps.

When a UE receives an indication to perform GNSS measurements in configured gaps and the indication is received before a time interval Δ from the start of a first configured gap, the UE is expected to perform GNSS measurement in the first configured gap. If the indication is received within the time interval Δ, the UE is expected to perform GNSS measurement in a next configured gap after the first configured gap.

When a UE receives an indication to perform GNSS measurements in configured gaps, the indication can include a period between two subsequent gaps, a duration of the gap for the UE to perform GNSS measurements, and a maximum time interval (or equivalently a number of periods that can be equal to one or larger) over which the UE is expected to report an information associated with the GNSS measurements and/or its GNSS position. After the maximum time interval, the UE is not expected to report the information.

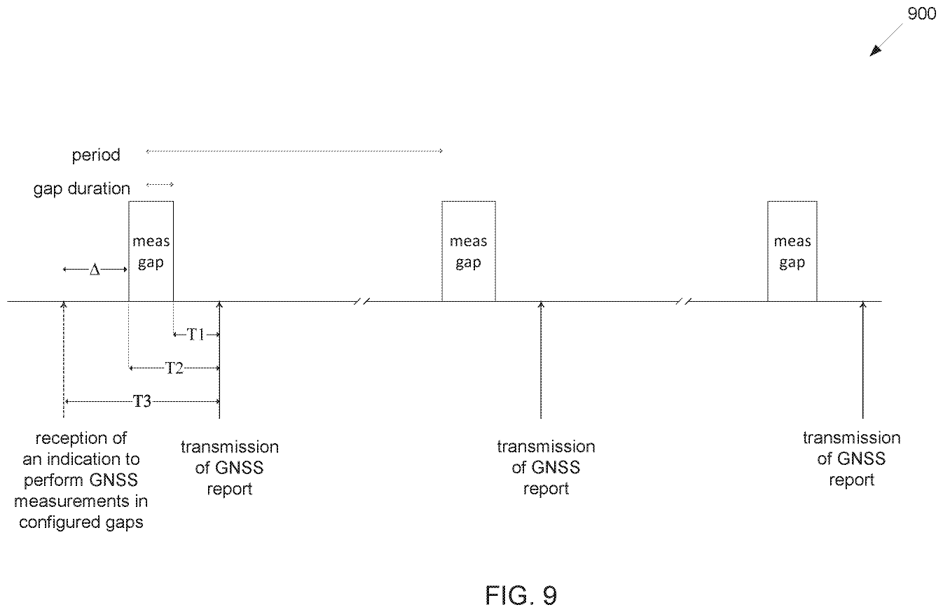

FIG. 9 illustrates an example of timing relationship of measurement gaps and transmission of GNSS reports 900 according to embodiments of the present disclosure. An embodiment of the timing relationship of measurement gaps and transmission of GNSS reports 900 shown in FIG. 9 is for illustration only.

A UE can be provided a gap duration and a gap period by a higher layer parameter and receive an indication to perform GNSS measurements in one or more of the configured gaps. The first measurement gap that the UE may use to perform GNSS measurements is subject to a minimum time interval between the reception of the indication and the start of the measurement gap (Δ). A UE is expected to transmit a GNSS report based on the GNSS measurements during the measurement gap after a time interval defined from the start of the measurement gap (T₁), or from the end of the measurement gap (T₂), or from the reception of the indication to perform GNSS measurements in the configured gap (T₃).

A UE can be configured with a periodicity for reporting an information associated to GNSS measurements, wherein the configuration includes an initial time instant and/or an initial PRB resource and a period between subsequent reports. The information to report can be GNSS measurements or UE's GNSS position derived from GNSS measurements. Based on the configuration, the UE determines time and frequency resources for reporting the information associated to GNSS measurements and transmits the information in the determined resources. It is possible that the UE transmits the information in the configured resources only if the UE receives an indication that enables the reporting in the configured resources. It is also possible that, regardless of UE receiving the indication, the UE transmits its GNSS report in the configured resources unless the UE is scheduled to transmit other information or channel or signal in such resources.

For example, a UE can receive a DCI format or a new configuration that schedules a PUSCH, or PUCCH, or PRACH, or SRS in the resources that were originally configured for the GNSS report, and the UE transmits the scheduled PUSCH, or PUCCH, or PRACH, or SRS and does not transmit the GNSS report. The reception of the DCI format or of the new configuration that schedules an uplink transmission in resources originally determined for GNSS report is an implicit indication for the UE not to transmit its GNSS report in the configured resources for the GNSS report and indicated by the DCI format or by the new configuration for a different transmission than the GNSS report or for reception, wherein the resources can include frequency resources within an active uplink BWP, or within a sub-band of an active uplink or downlink BWP.

For a half-duplex UE (HD-UE) in paired spectrum that is not capable of simultaneous transmissions and receptions on a serving cell with paired spectrum, as for example a RedCap UE or a NB-IoT UE, if the HD-UE is configured by higher layers to transmit its GNSS report in a set of symbols, the HD-UE transmits its GNSS report in the set of symbols if the HD-UE does not detect a DCI format that indicates to the HD-UE to transmit a PUSCH, or PUCCH, or PRACH, or SRS in at least one symbol of the set of symbols, otherwise the HD-UE transmit the PUSCH, or PUCCH, or PRACH, or SRS. The HD-UE does not receive a PDCCH, or PDSCH, or CSI-RS, or DL PRS in the set of symbols.

For a full-duplex UE (FD-UE) in paired spectrum or in sub-bands of an active DL or UL BWP, wherein one or more first sub-bands are for UL and one of more second sub-band are for DL, that is capable of simultaneous transmissions and receptions on a serving cell, if the FD-UE is configured by higher layers to transmit its GNSS report in a set of symbols of an UL sub-band, the FD-UE transmits its GNSS report in the set of symbols of the UL sub-band if the FD-UE does not detect a DCI format that indicates to the FD-UE to transmit a PUSCH, or PUCCH, or PRACH, or SRS in at least one symbol of the set of symbols. If the FD-UE is configured by higher layer to receive a PDCCH, or PDSCH, or CSI-RS, or DL PRS in the set of symbols, or detects a DCI format that indicates to the FD-UE to receive the PDSCH, or CSI-RS, or DL PRS, the FD-UE can receive the PDCCH, or PDSCH, or CSI-RS, or DL PRS in the set of symbols.

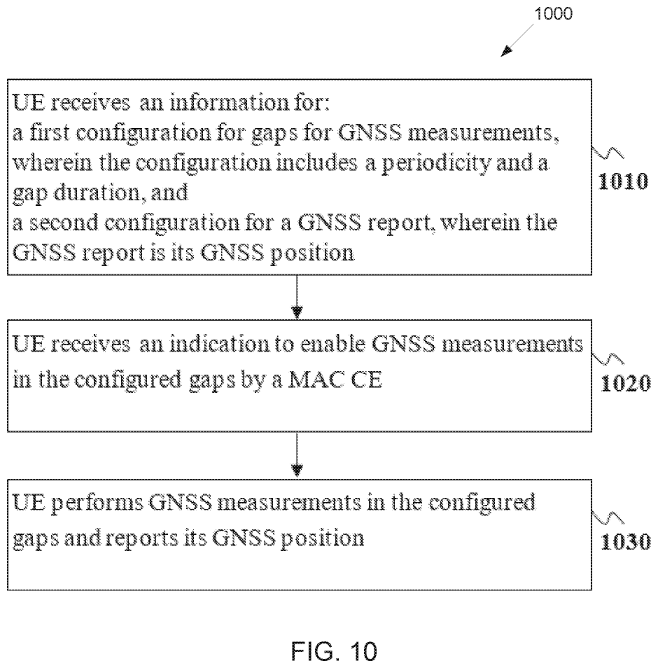

FIG. 10 illustrates a flowchart of a UE method 1000 for configuring gaps for GNSS measurements and enabling to perform GNSS measurements and reports according to embodiments of the present disclosure. The method 1000 as may be performed by a UE (e.g., 111-116 as illustrated in FIG. 1). An embodiment of the method 1000 shown in FIG. 10 is for illustration only. One or more of the components illustrated in FIG. 10 can be implemented in specialized circuitry configured to perform the noted functions or one or more of the components can be implemented by one or more processors executing instructions to perform the noted functions.

A UE receives an information for a first configuration for gaps for GNSS measurements, wherein the configuration includes a periodicity and a gap duration, and a second configuration for a GNSS report, wherein the GNSS report is its GNSS position (1010). The UE receives an indication to enable GNSS measurements in the configured gaps by a MAC CE (1020). The UE performs GNSS measurements in the configured gaps and reports its GNSS position (1030). In one embodiment, the UE behavior is according to the three steps 1010, 1020, and 1030 of FIG. 10. In another embodiment, step 1020 is omitted.

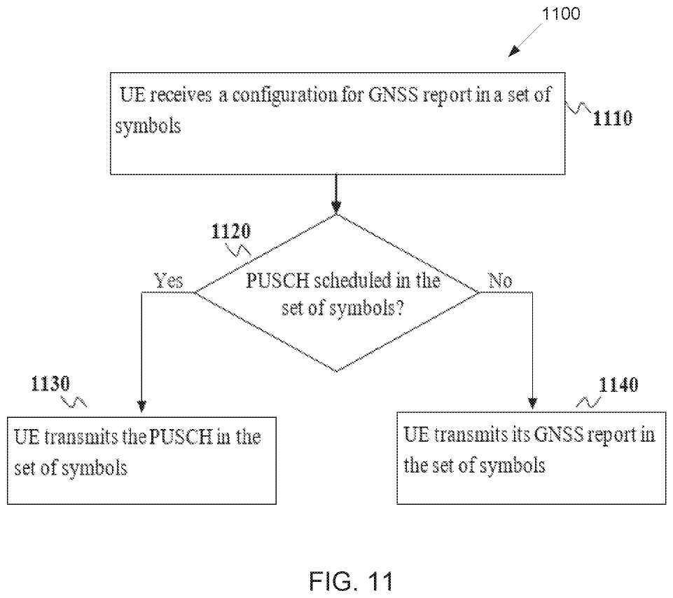

FIG. 11 illustrates a flowchart of UE method 1100 for reporting a GNSS position according to embodiments of the present disclosure. The method 1100 as may be performed by a UE (e.g., 111-116 as illustrated in FIG. 1). An embodiment of the method 1100 shown in FIG. 11 is for illustration only. One or more of the components illustrated in FIG. 11 can be implemented in specialized circuitry configured to perform the noted functions or one or more of the components can be implemented by one or more processors executing instructions to perform the noted functions.

A UE receives a configuration for GNSS report in a set of symbols (1110). When the UE receives a configuration or a DCI format that schedules a PUSCH, or a PUCCH, or a PRACH, or an SRS, in the set of symbols (1120), the UE transmits the PUSCH, or PUCCH, or PRACH, or SRS in the set of symbols (1130). Otherwise, the UE transmits its GNSS report in the set of symbols (1140).

When a UE is not configured measurement gaps and receives an indication to report an information associated with GNSS measurements, the UE is expected to perform GNSS measurements and send a GNSS report to the network within a time interval T from the time instant when the UE receives the indication. The time interval T can be indicated to the UE by a SIB, a UE-specific RRC parameter, a MAC CE, or a DCI format. The information of the time interval T can be part of the indication to report the information associated with GNSS measurements or can be signaled separately. The time interval T can be associated to a maximum time interval of a timer at the network and/or at the UE.

For example, a timer at the network can start when sending the indication to the UE, and if the timer expires and no GNSS report is received, the network may send another indication and restart the timer. A timer at the UE can start when receiving the indication, and the UE performs the GNSS measurements and sends the GNSS report before expiration of the timer. If the UE is unable to send the GNSS report before the timer expires, or equivalently, before the maximum time interval T has passed, the UE is not expected to send the GNSS report. The timer at the network takes into account also the propagation delay between the transmission by the network and the reception by the UE of the indication.

When a UE is scheduled to transmit a PUSCH with a number of Nᵣₑₚ repetitions over a number of consecutive or non-consecutive slots, and a GNSS measurement gap is configured in one or more of the slots of the number of slots scheduled for the PUSCH transmission, the UE may transmit the PUSCH repetitions or perform the GNSS measurements.

In one example, PUSCH repetitions scheduled in the one or more slots of the slots of the number of slots are postponed after the gap, and after the UE acquires the GNSS position and updates the TA. The postponed repetitions are transmitted with the updated TA.

In one example, PUSCH repetitions scheduled in the one or more slots of the slots of the number of slots are dropped. Repetitions after the GNSS measurement gap, and after the UE acquires the GNSS position and updates the TA, are transmitted with the updated TA.

In one example, PUSCH repetitions scheduled in the one or more slots of the slots of the number of slots are transmitted with the current TA, and the does not perform GNSS measurements in the gap configured in one or more of the slots of the number of slots.

Whether to transmit, postpone or drop repetitions in slots where the GNSS measurement gap is configured may depend on the type of uplink transmission. For example, if the transmission of PUSCH repetitions is semi-statically configured, repetitions are dropped, and if dynamically scheduled, repetitions are postponed. And in case the PUSCH transmission is without repetitions, the PUSCH transmission is postponed.

Whether to transmit the PUSCH or perform the GNSS measurements may also depend on a TA validity timer. If the TA validity timer has not expired, the UE does not perform the GNSS measurements in the GNSS measurement gap and transmits the PUSCH repetitions with the current TA. If the TA validity timer has expired or expires in one of the slots of the gap, the UE perform the GNSS measurements in the GNSS measurement gap.

Whether to transmit the PUSCH or perform the GNSS measurements may also depend on a reception of an indication that enables the UE to perform GNSS measurements in the configured GNSS measurement gaps.

For an FD-UE in paired spectrum or in sub-bands (SBs) of an active DL or UL BWP, that is capable of simultaneous transmissions and receptions, if the FD-UE is scheduled or configured to transmit a PUSCH with a number of Nᵣₑₚ repetitions over a number of consecutive or non-consecutive slots, and a GNSS measurement gap is scheduled or configured in one or more of the slots of the number of slots scheduled for the PUSCH transmission or, generally in symbols scheduled for the PUSCH transmission, if frequency resources scheduled for the PUSCH transmission and frequency resources for reception in the GNSS measurement gap do not overlap, the FD-UE can simultaneously transmit the PUSCH repetitions and receive a downlink channel or signal to perform GNSS measurements in such slots or symbols.

In case of overlapped frequency resources, for example if the downlink channel or signal to perform GNSS measurements occupies frequency resources over a BWP, and a sub-band of the BWP is configured for UL, and a PUSCH transmission is scheduled in the sub-band, the PUSCH transmission in the overlapping slot or symbols is postponed or dropped. It is also possible that if the downlink channel or signal to perform GNSS measurements occupies frequency resources over the entire BWP, or in general occupies frequencies of the sub-band of the BWP that is configured for UL, in a first set of symbols of a slot, and the PUSCH transmission occupies frequency resources within the UL sub-band in a second set of symbols of the slot, wherein the first set of symbols and the second set of symbols do not overlap, the UE receives the downlink channel or signal in the first set of symbols and transmits the PUSCH in the second set of symbols. The PUSCH in the second set of symbols is transmitted with a TA that is not updated based on the GNSS measurements performed in the first set of symbols, and PUSCH transmissions in subsequent slots are transmitted with an updated TA. It is possible that the TA update is applied to the PUSCH transmission in the next slot after the slot where the GNSS measurements are performed or after a number of subsequent slots. The number of slots between the slot with the GNSS measurement gap and the slot with an uplink transmission with an updated TA, or the corresponding time interval between the GNSS measurement gap and the PUSCH transmission with the updated TA, can depend on a UE capability, and can be provided to the UE by a higher layer parameter. Whether the PUSCH transmission in the second set of symbols can be transmitted with an updated TA based on the GNSS measurements performed in the first set of symbols can also depend on the UE capability.

For a FD-UE that operates in a BWP that includes one or more sub-bands for the UL and one or more sub-bands for the DL, a downlink channel or signal used to perform GNSS measurements in a GNSS measurement gap may occupy frequency resources over the entire BWP.

In one example, a slot configured with sub-bands of a BWP, wherein each symbol of the slot can be either a DL symbol in the DL sub-band or an UL symbol in the UL sub-band, also referred as a sub-band (SB) slot, does not include the GNSS measurement gap that occupies frequency resources over the entire BWP or frequency resources of the UL sub-band.

In another example, the SB slot can include the GNSS measurement gap that occupies frequency resources over the entire BWP or frequency resources of the UL sub-band. The transmission of a PUSCH, or a PUCCH, or a PRACH, or an SRS in the UL sub-band in the SB slot depends on whether the set of DL symbols of the GNSS measurement gap includes UL symbols of the PUSCH, or PUCCH, or PRACH, or SRS. If there is an overlap between the PUSCH resource allocation with PRBs that are scheduled for the GNSS measurement gap, the UE may assume that the PRBs for the GNSS measurement gap are not available for PUSCH in the OFDM symbols where the UE expects to receive a signal used for GNSS measurements.

In yet another example, whether to allow the reception over the UL sub-band during the GNSS measurement gap in an SB-slot is subject to a UE capability and/or to a configuration based on the UE capability and/or a configuration of the GNSS measurement gap or of the full-duplex operation in the sub-band of the BWP. In yet another example, whether to allow the transmission in the UL sub-band of the BWP of the UL channel in symbols that overlap with symbols of the GNSS measurement gap that occupy the entire BWP depends on whether the UL channel is semi-statically configured (e.g., CG-PUSCH) or dynamically scheduled (PUSCH scheduled by a DCI format), or depends on a priority between DL reception during the GNSS measurement gap and UL channel. If DL reception during the GNSS measurement gap has higher priority index (lower priority) of the UL channel transmission, the UE can receive the DL channel for the GNSS measurements in frequencies of the BWP outside the UL sub-band of the BWP and transmit the UL channel in the UL sub-band of the BWP. If DL reception during the GNSS measurement gap has lower priority index (higher priority) of the UL channel transmission, the UE can receive the DL channel for the GNSS measurements in the entire BWP and postpone or drop the transmission of the UL channel. In yet another example, whether to allow the UL transmission in symbols that overlap in time and frequency with the GNSS measurement gap depends on whether the UE is in connected mode or not. Transmission of a Msg3 PUSCH or a MsgA PUSCH or a PUCCH when the UE does not have dedicated PUCCH resources, during the random access procedure, may be prioritized or deprioritized when occurs during the GNSS measurement gap. Further, the uplink transmission may be prioritized or deprioritized depending on whether the GNSS measurement gap is semi-statically configured or indicated by a MAC CE or by a DCI format.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) comprising:
a transceiver configured to receive information relating to:
a measurement gap for Global Navigation Satellite System (GNSS) measurements, and
a first time interval for transmission of feedback information associated with the GNSS measurements; and
a processor operably coupled to the transceiver, the processor configured to determine:
based on the information relating to the measurement gap, a start of the measurement gap,
the feedback information associated with the GNSS measurements during the measurement gap, and
based on the information relating to the first time interval, a transmission time for the feedback information,
wherein the transceiver is further configured to transmit the feedback information at the transmission time.

2. The UE of claim 1, wherein:
the transceiver is further configured to receive an indication to perform the GNSS measurements and information relating to a second time interval,
the second time interval is associated with the reception of the indication, and
the start of the measurement gap is based on the indication to perform GNSS measurements and the second time interval.

3. The UE of claim 1, wherein the feedback information includes at least one of:
a GNSS position fix time duration,
a validity time interval, and
an inability to acquire the GNSS position fix time duration.

4. The UE of claim 1, wherein:
the processor is further configured to determine a validity time interval associated with the feedback information,
the validity time interval starts at the transmission time of the feedback information,
the feedback information is a GNSS position fix time duration, and
the transceiver is further configured to transmit information associated with the determined validity time interval.

5. The UE of claim 1, wherein:
the processor is further configured to determine a validity time interval associated with a latest transmitted feedback information,
the latest transmitted feedback information is a GNSS position fix time duration, and
the transceiver is further configured to transmit information associated with the determined validity time interval.

6. The UE of claim 1, wherein:
the transceiver is further configured to receive information for transmission of a channel over a first number of slots, wherein the first number of slots includes one or more slots that overlap in time with slots of the measurement gap; and
the processor is further configured to:
drop the transmission of the channel during the measurement gap,
postpone the transmission of the channel to slots after the measurement gap, or
transmit the channel over the one or more slots that overlap in time and do not overlap in frequency with slots of the measurement gap.

7. The UE of claim 1, wherein:
the processor is further configured to determine that a validity time interval associated with GNSS measurements has expired, and
the transceiver is further configured to transmit an indication that the validity time interval has expired.

8. A base station (BS) comprising:
a transceiver configured to transmit information relating to:
a measurement gap for Global Navigation Satellite System (GNSS) measurements, and
a first time interval for reception of feedback information associated with the GNSS measurements; and
a processor operably coupled to the transceiver, the processor configured to determine:
based on the information relating to the measurement gap, a start of the measurement gap,
the feedback information associated with the GNSS measurements during the measurement gap, and
based on the information relating to the first time interval, a reception time for the feedback information,
wherein the transceiver is further configured to receive the feedback information at the reception time.

9. The BS of claim 8, wherein:
the transceiver is further configured to transmit an indication to perform the GNSS measurements and information relating to a second time interval,
the second time interval is associated with the transmission of the indication, and
the start of the measurement gap is based on the indication to perform GNSS measurements and the second time interval.

10. The BS of claim 8, wherein the feedback information is at least one of:
a GNSS position fix time duration,
a validity time interval, and
an inability to acquire the GNSS position fix time duration.

11. The BS of claim 8, wherein:
the processor is further configured to determine a validity time interval associated with the feedback information,
the validity time interval starts at the reception time of the feedback information,
the feedback information is a GNSS position fix time duration, and
the transceiver is further configured to receive information associated with the determined validity time interval.

12. The BS of claim 8, wherein:
the processor is further configured to determine a validity time interval associated with a latest received feedback information,
the latest received feedback information is a GNSS position fix time duration, and
the transceiver is further configured to receive information associated with the determined validity time interval.

13. The BS of claim 8, wherein:
the processor is further configured to determine that a validity time interval associated with GNSS measurements has expired, and
the transceiver is further configured to receive an indication that the validity time interval has expired.

14. A method comprising:
receiving information relating to:
a measurement gap for Global Navigation Satellite System (GNSS) measurements, and
a first time interval for transmission of feedback information associated with the GNSS measurements;
determining:
based on the information relating to the measurement gap, a start of the measurement gap,
the feedback information associated with the GNSS measurements during the measurement gap, and
based on the information relating to the first time interval, a transmission time for the feedback information; and
transmitting the feedback information at the transmission time.

15. The method of claim 14, further comprising:
receiving an indication to perform the GNSS measurements and information relating to a second time interval, wherein:
the second time interval is associated with the reception of the indication, and
the start of the measurement gap is based on the indication to perform GNSS measurements and the second time interval.

16. The method of claim 14, wherein the feedback information includes at least one of:
a GNSS position fix time duration,
a validity time interval, and
an inability to acquire the GNSS position fix time duration.

17. The method of claim 14, further comprising:
determining a validity time interval associated with the feedback information, wherein:
the validity time interval starts at the transmission time of the feedback information, and
the feedback information is a GNSS position fix time duration; and
transmitting information associated with the determined validity time interval.

18. The method of claim 14, further comprising:
determining a validity time interval associated with a latest transmitted feedback information, wherein the latest transmitted feedback information is a GNSS position fix time duration; and
transmitting information associated with the determined validity time interval.

19. The method of claim 14, further comprising:
receiving information for transmission of a channel over a first number of slots, wherein the first number of slots includes one or more slots that overlap in time with slots of the measurement gap; and
one of:
dropping the transmission of the channel during the measurement gap,
postponing the transmission of the channel to slots after the measurement gap, or
transmitting the channel over the one or more slots that overlap in time and do not overlap in frequency with slots of the measurement gap.

20. The method of claim 14, further comprising:
determining that a validity time interval associated with GNSS measurements has expired; and
transmitting an indication that the validity time interval has expired.
